(19) United States
(12) Patent Application Publication
(10) Pub. No.: US 2026/0208071 A1
(43) Pub. Date: Jul. 23, 2026

(54) SEPARATION SYSTEM FOR OIL-WATER MIXTURE CONDENSATE

(71) Applicant: MIKROPOR MAKINA SANAYI VE TICARET ANONIM SIRKETI, Ankara (TR)

(72) Inventor: Ibrahim Kemal YAZICI, Ankara (TR)

(21) Appl. No.: 18/876,431

(22) PCT Filed: May 20, 2024
(86) PCT No.: PCT/TR2024/050496

§ 371 Date: Dec. 18, 2024

(30) Foreign Application Priority Data
May 22, 2023 (TR) 2023/005735

(51) Int. Cl. B01D 17/02; B01D 17/04; C02F 1/40; C02F 101/32

(52) U.S. Cl. CPC B01D 17/0214; B01D 17/0202; B01D 17/045; C02F 1/40; C02F 2101/32

(57) ABSTRACT

Disclosed herein is a separation system with a reusable layer for separating the compressor drainage with an oil concentration of 500-3000 ppm formed by the combination of water generated by the compression of air by the compressor screw block, oil used for cooling and lubricating the screw block, dirt, and other impurities in the environment. By using the separation system, the oil concentration of the wastewater drainage from the compressor can be reduced to a maximum level of 10 ppm without any energy cost, making it compliant with environmental regulations.

This application is a National Phase entry of International Application No. PCT/TR 2024/050496 under § 371 and claims the benefit of Turkish Patent Application No. 2023/005735, filed May 22, 2023, which is hereby incorporated by reference in its entirety.

### FIELD OF THE DISCLOSURE

The disclosure relates to a compact separation system for separating the water and oil in the compressor drainage containing water, oil, and dirt, which are considered industrial waste from compressed air compressors, minimizing the oil concentration in the water and allowing the filter elements to be reused.

### BACKGROUND

In compressed air systems, a condensate is formed including dirt, oil, and other impurities in addition to water. The mixture of oil and water is classified as hazardous industrial waste. Environmental regulations strictly prohibit the disposal of this condensate without proper treatment to separate the oil from the condensate.

Compressed air compressors used in industry have separate oil and water separator systems in their lines. The oil, air, and water mixed in the screw block of the compressors go through a series of filtration processes in the compressor. For the oil-water mixture separated from the line with the help of filters, the concentration of oil that can be found in the water is determined as a maximum of 10 ppm in general environmental regulations and ISO14001 Environmental Management System standard. However, in general, the oil concentration of the condensate discharged from the compressor drain is around 500-3000 ppm. In this case, the oil concentration does not comply with environmental regulations and causes significant damage to the environment.

Condensate separation systems used in the industry generally perform active carbon-based filtration. Technical problems with these systems include the high energy cost of Separation processes and the fact that activated carbon-based filtration is usually performed directly with drainage containing high oil concentrations and impurities. This reduces the service life of activated carbon and therefore the need for frequent replacement of the activated carbon-based filter. In addition, sending the drainage containing impurities directly to the filter may cause clogging in the system in a short time or the impurities may accumulate at some point in the system, requiring continuous maintenance of the system and increasing the cost.

In the current art, the systems generally contain polypropylene fiber. The use of virgin synthetic fibers for filtration processes creates an economic disadvantage and may not be sufficient to provide the required absorption.

Another technical problem with systems in the art is that the materials for oil adsorption are not suitable for reuse. This causes the filtering process to become ineffective after a certain period. Therefore, there is often a need to use new materials.

There are documents in the art on systems for the separation of water and oil-containing compressor drainage from compressed air compressors.

The patent document No. US2021355002A1 may be referred to as an example of the current state of the art. In its most general form, the document describes a separator for separating compressor drains containing oil and water before disposal. The operating principle of the separator mentioned in the document is based on liquid pressure. The separator comprises a first section that utilizes the difference in density to separate the non-oil portion of the condensate. The condensate is then transferred through a pipe to a main filter and the separation process continues. Since the separation process is carried out in two stages in the system of the document, the system may be insufficient in terms of minimizing the oil concentration. In the system in question, the transfer of impurities with a density higher than 1 g/cm³ to the main filter section may cause clogging of the filter or accumulation at some point in the system and cause different maintenance costs. In addition, in the system of the document, the separator works with the liquid pressure technique and therefore a compressor that provides compressed air is needed to obtain control air. The fact that the system includes elements such as compressors, valves, and sensors require the use of electricity and causes energy consumption. These elements may malfunction or require maintenance during their lifetime, resulting in extra costs. The polymers used as filtering material in the said system can also create cost disadvantages. In addition, due to the presence of a pressurization process in the system, one could expect concerns associated with potential risks to be posed by pressurized systems.

Another example of the current state of the art is the patent document No. US5143611A. The said document describes discharged oil and water condensate separated by the operation of various machines, especially air compressors. A large tank with turbulence-free primary and secondary separation chambers of this condensate receives oil and water mixtures and separates the oil from the water by a two-phase gravity separation. The third stage of oil and water separation is provided through an external activated carbon filter to produce clean water. However, in the document, an adequate pre-separation is not applied for the separation of the oil from the water and therefore the activated carbon will quickly reach the saturation level. Therefore, it can be inferred that the use of activated carbon will increase and also the amount of oil cannot be reduced to minimum concentration with minimum energy.

### SUMMARY

To eliminate the above-mentioned disadvantages, an economical and compact separation system has been developed, which ensures that the separation of oil and water in the compressor drainage is carried out with zero energy, and the oil concentration in the water can be reduced to very low levels and the filters can be reused.

The disclosure relates to a separation system for separating condensate containing water and oil from compressors used in compressed air lines.

In more detail, the disclosure relates to a separation system for separating a mixture of oil, dirt, and other impurities, in addition to water, which is mixed in the compressor screw block used in air systems and discharged through filters in the compressor line.

An object of at least one embodiment of the invention is to separate the oil and water in the compressor drainage and to reduce the oil concentration in the water to 10 ppm and below with zero energy cost.

Another object of at least one embodiment of the invention is to prevent activated carbon-based filters in the separation system from reaching saturation in a short time-due to the earlier separation methods-by reducing the oil concentration in the condensate, thereby extending their service life.

Another object of at least one embodiment of the invention is to perform oil absorption during the filtration process in such a way as to separate oil in an effective and high concentration and to bring the material providing oil absorption to a reusable structure.

Another object of at least one embodiment of the invention is to develop a system comprising an economical and environmentally friendly filtration material that provides high oil absorption. Another object of at least one embodiment of the invention is to develop a compact system that allows the separation of oil and water condensate in accordance with environmental regulations.

### BRIEF DESCRIPTION OF THE FIGURES

FIG. 1: Exploded view showing the internal parts of the separation system of at least one embodiment of the invention.

FIG. 2: An exploded view showing the oil absorbing layer (4), spring (13), first cap (14), second cap (15), and housing (16) in the second oil trap (5) of the separation system of at least one embodiment of the invention.

FIG. 3: An exploded view showing the cap (19) of the separation system of at least one embodiment of the invention, the float (20), the gap (21), the second oil trap (5), the slot (18) and the cartridge (17) containing the activated carbon material in the third oil trap.

FIG. 4: Perspective (a) and exploded perspective (b) view of the separator (2) of the separation system of at least one embodiment of the invention.

### DETAILED DESCRIPTION

At least one embodiment of the invention is a system for separating oil-water condensate from the compressor in compressed air lines, comprising the following:
a first oil trap comprising at least one separator (2) for performing first stage separation of the water-oil containing compressor drainage entering the system via at least one inlet port (1),
at least one oil separation chamber (3) in which the liquid passing through the separator (2) in the said first oil trap is collected, enabling the second stage separation process to be carried out based on density difference and separating the oil due to its density difference,
at least one second oil trap (5) in the said oil separation chamber (3), to which the liquid separated from the oil is conveyed, having at least one oil absorbing layer (4) with oleophilic and hydrophobic properties for performing the third stage of separation,
at least one third oil trap containing activated carbon material, through which the liquid from the mentioned second oil trap (5) is conveyed, enabling the oil to be retained for the fourth stage separation process and
at least one water outlet port (6) for the discharge of the de-oiled water from the system.

In an embodiment of the invention, the oil absorbing layer (4) comprises a mixture of synthetic fibers. In one embodiment, said synthetic fiber blend comprises recycled synthetic fiber.

In an embodiment of the invention, the mixture of synthetic fibers comprises polyester and/or nylon fibers.

In one embodiment of the invention, the blend of synthetic fibers comprises fibers of different lengths to increase their interstitial spaces and to ensure effective adsorption capacity.

An embodiment of the invention comprises a depressurization chamber (7) with at least one inlet port (1) for the arriving condensate, which allows the inlet pressure of the condensate to be reduced to prevent damage to the components in the system. In an embodiment of the invention, the depressurization chamber (7) comprises at least one pressure port (9) containing at least one filter (8) for discharging the incoming excess compressed air.

In an embodiment of the invention, the depressurization chamber (7) comprises at least one diverter (11) for transmitting the condensate reduced to atmospheric pressure to the separator (2) with a steady flow.

One embodiment of the invention comprises at least one O-ring (10) located at the connection points of the separator (2), which prevents leakage.

In an embodiment of the invention, the separator (2) comprises at least one perforated inner sheet (26), at least one perforated outer sheet (25) positioned to surround the inner sheet (26), and at least one filter element (27) between the inner sheet (26) and the outer sheet (25). In another embodiment of the invention, at least one separator cap (28) for securing the outer sheet (25), the inner sheet (26), and the filter element (27), having at least one slot for seating the aforementioned outer sheet (25), the inner sheet (26) and the filter element (27) and at least one hole through which drainage can pass. In an embodiment, there are two separator caps (28) to be positioned at the inlet and outlet of the separator (2).

In an embodiment of the invention, the second oil trap (5) comprises at least one spring (13) for squeezing the oil absorbing layer (4) and disposing of the oil accumulated on the layer, thereby making it reusable. In one embodiment, said second oil trap (5) has a first cap (14) and a second cap (15) positioned between the oil absorbing layer (4) and the spring (13). In an embodiment, said covers have grid-shaped openings on top. In another embodiment, it comprises a housing (16) which carries the said oil absorbing layer (4), a spring (13), and additionally a first cap (14) and a second cap (15), the lower part of the housing (16) has a permeable structure in the form of a grid to allow the passage of liquid after the third stage separation process.

In one embodiment of the invention, the oil separation chamber (3) is provided with at least one oil outlet port (22) for the removal of the oil phase from the system, which remains on top due to the density difference. In an embodiment, there is at least one waste oil collection bottle (23) for collecting the oil discharged from the oil outlet port (22). An embodiment of the invention comprises at least one channel and/or at least one stage passage pipe (12) for transferring the liquid obtained as a result of the separation of oil in the oil separation chamber (3) to the second oil trap (5).

In an embodiment of the invention, the third oil trap comprises at least one cartridge (17) in which the activated carbon material is positioned. In an embodiment, said cartridge (17) has at least one slot (18) fixing the activated carbon material/filter. In another embodiment of the invention, there is at least one cartridge cap (19) on the cartridge (17). In an embodiment, there is at least one float (20) and at least one gap (21) on the cartridge cap (19) for the engagement of the float (20), which indicates that the amount of liquid in at least one compartment has reached a risky level.

In an embodiment of the invention, an outer housing surrounding the system for the protection of the parts of the system is provided. In one embodiment of the invention, said outer casing has two compartments. In the stated embodiment of the invention, there are openings/connections on the outer casing through which the oil outlet port (22) and the water outlet port (6) can pass/be assembled.

In one embodiment of the invention, at least one nut is provided for securing the inlet ports (1) and the output ports.

The operation method of the system of an embodiment of the invention in its most general form; comprises the following process steps:
introducing the water-oil containing drainage coming out of the compressor into the system through at least one inlet port (1) and transmitting it to the separator (2) in the first oil trap,
performing the first stage separation process in the separator (2),
transmitting the liquid passing through the separator (2) to the oil separation chamber (3) to separate the water and oil based on the density difference for performing the second stage separation process,
transmitting the liquid contained in the oil separation chamber (3) and separated from the oil to the second oil trap (5) comprising at least one oleophilic and at least one oil absorbing layer (4) with hydrophobic properties for performing the third stage separation process,
transmitting the liquid exiting the said second oil trap (5) to the third oil trap containing activated carbon material, where the oil is retained, thereby performing the fourth stage separation process, and
removing the de-oiled water from the system through the water outlet port (6).

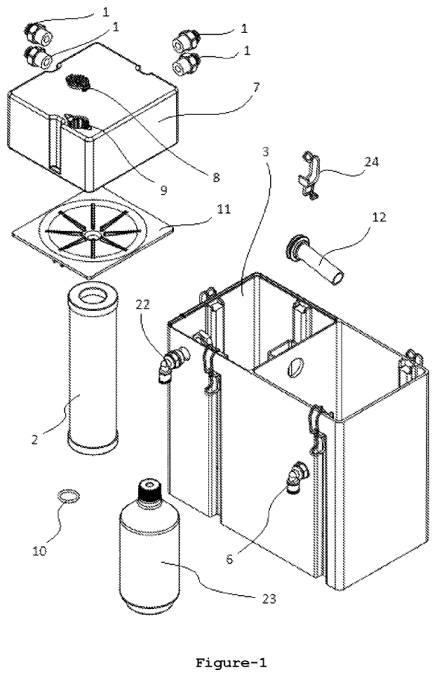

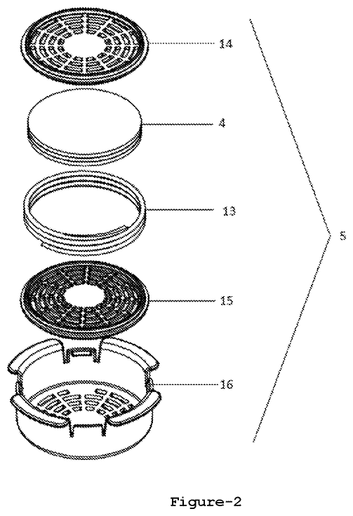

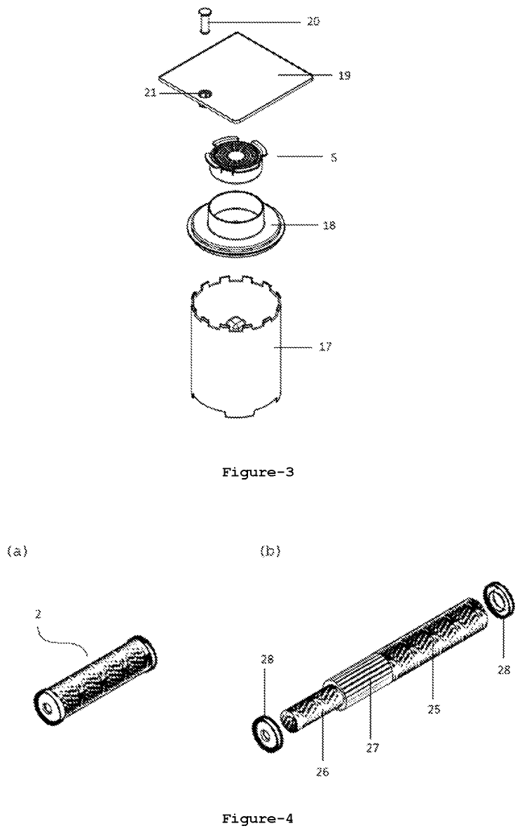

The elements of the system according to an embodiment of the invention are described in detail below and are shown in FIG. 1 to FIG. 4.

The separation system of at least one embodiment of the invention comprises the following components: a depressurization chamber (7) with inlet ports (1) for condensate from the compressor outlet or wet tank and a pressure port (9) with a special filter (8) for discharging excess compressed air; an outer housing having two sections and for which stepwise separation operations are to take place; a diverter (11) for transmitting the atmospherically depressurized condensate from the depressurization chamber (7) to the next stage in the first section of the outer housing with a stable flow; a specially designed separator (2) to perform the first stage separation of the oil in the condensate from the diverter (11); the material of the o-ring (10) for preventing leakage at the connection point of the separator (2); the oil outlet port (22) positioned on the upper side of the side surface of the first section for removing the oil accumulated in the first part of the outer casing where the second stage separation process takes place and a waste oil collection bottle (23) for collecting the waste oil coming out of the oil outlet port (22); a channel that allows the oil to be left on top and the water to be transferred to the second section by using the density difference and the stage passage pipe (12) that will transfer from the channel outlet to the center of the part where the third stage separation process will be performed; a special oil absorbing layer (4) with oil retention capability to reduce the oil in the water coming through the stage passage pipe (12) to a maximum level of 10 ppm; a spring (13) in contact with the oil absorbing layer (4) and used for squeezing the oil absorbing layer (4); the first cap (14) and the second cap (15), which ensure the stability of the oil absorbing layer (4) and the spring (13), and the second oil trap (5), which carries them all, has a fluid transmitting housing (16) ; a cartridge (17), which is the third oil trap in which the activated carbon material is positioned for the fourth stage of separation; at least one slot (18) for fixing the activated carbon material/filter in said cartridge (17), a cap (19) on the cartridge (17) and at least one gap (21) and float (20) for engaging the float (20) on said cap (19), which indicates that the amount of liquid in the at least one compartment has reached a risky level; the water outlet port (6) for removing the oil-separated water from the cartridge (17), the nut for securing the inlet ports (1) and the outlet ports, the metal clips (24) for connecting with the outer housing depressurization chamber (7) and the cap (19).

The system according to an embodiment of the invention consists of two parts. The separation system comprises a fourth-stage separation process. The condensate from the drainage line with an oil concentration in the range of 500-3000 ppm first enters the depressurization chamber (7) for the first stage separation process. This first part reduces the incoming oil-water mixture/condensate to atmospheric pressure against the pressure that may come from the line. Excess compressed air in the depressurization chamber (7) is discharged through the pressure port (9) located at the top of the depressurization chamber (7) and containing the special filter (8). The condensate enters the outer casing with a stable flow through the condensate diverter (11). When the oil-water mixture first enters the system, it passes through a specially designed separator (2) that will perform the first stage oil retention process. The separator (2) comprises at least one perforated outer sheet (25) ; at least one perforated inner sheet (26); at least one filter element (27) for filtering the water and oil mixture between the outer sheet (25) and the inner sheet (26); at least two separator caps (28) located at both ends of the cylinder formed by the outer sheet (25), inner sheet (26), filter element (27) parts, which has a slot for seating the said outer sheet (25), inner sheet (26), filter element (27) parts and a hole in the middle for the liquid to enter, allowing the outer sheet (25), inner sheet (26), filter element (27) to be secured. The liquid passing through the separator (2), which is the first oil trap, is collected in the first section of the outer casing. Then, in the first section, the separation process with the density difference, which is the second stage separation process, is carried out in the oil separation chamber (3). The oil accumulated on the top due to the density difference is transferred to the waste oil collection bottle (23) from the oil outlet port (22) on the upper part of the side surface of the first section on the outer casing. The remaining water is transferred to the second section through the channel. It is transferred from the channel outlet through the stage passage pipe (12) to the center of the second oil trap (5) in the second section, where the next separation will take place. After these processes, the oil concentration of the water coming to the second section is reduced to approximately 250 ppm. The oil-water mixture arriving at the second section first passes through the oil absorbing layer (4) and the third stage separation process is carried out. This oil absorbing layer (4) has a high oil retention property. It allows water to pass through while keeping oil on top. The part where the oil absorbing layer (4) is located adds a squeezability feature to the oil absorbing layer (4) with the help of a spring (13) located inside. With this squeezing process, the oil accumulated on the oil absorbing layer (4) can be eliminated and the oil absorbing layer (4) can be used again. Then, the water conveyed through the oil absorbing layer (4) is passed through the cartridge (17) filled with activated carbon material, thereby the fourth stage separation process is carried out. After this process, the water containing a maximum oil concentration of 10 ppm fills the second part. Through the water outlet port (6) on the side surface of this second section, the water that now complies with the legal standards can be supplied to the drainage line.

The oil absorbing layer (4) in the system of at least one embodiment of the invention comprises a fiber mixture that naturally adsorbs the oils in the water-oil mixture and at the same time allows water to flow through the material. The absorbing layer (4) holds the oils and greases and does not release them back into the water. The material contained in the oil absorbing layer (4) has an adsorbing capacity of an average of 13 times its own weight in liquid hydrocarbons, making it cost-effective compared to many conventional filtration materials. Approximately 85%-90% of the oils adsorbed with the oil absorbing layer (4) can be removed from the material by applying a press. The material in the aforementioned layer is environmentally friendly and user-friendly. It does not leak harmful substances into the environment during use and produces minimal residue or ash when incinerated.

The fact that the oil absorbing layer (4) in the system of one embodiment of the invention comprises a blend of synthetic fibers and more specifically a mixture of recycled synthetic fibers creates an economic advantage and also contributes to the environment. Said layer comprises a fiber matrix with interstitial spaces to ensure a maximum degree of adsorption. In this way, the oil retention capacity is increased and the amount of oil in the drain to the activated carbon is minimized.

The most important advantages of the said at least one embodiment invention are as follows: firstly, reducing a significant part of the oil concentration with a special separator (2) element of the waste condensate, transferring the remaining water in the first section to the second chamber through the channel based on the difference in density, bringing the oil concentration to very low levels before activated carbon-based filtration with the help of the oleophilic (oil retaining) and hydrophobic (water repellent) structure of the oil-absorbing material, and thus prolonging the service life of activated carbon, the reusability of the material resulting from the squeezing action by the squeezing mechanism of at least one embodiment of the invention, which is performed when the oil absorbing layer (4) material reaches saturation

Thanks to the condensate separation system of at least one embodiment of the invention, the oil concentration of the wastewater drainage from the compressor is reduced to a maximum level of 10 ppm without any energy cost, making it compliant with the environmental regulations.

After the oil absorbing layer (4) material reaches saturation, the condensate separation system of at least one embodiment of the invention allows it to be reused by a squeezing operation performed by a spring (13) located in the separation system. The fact that the materials can be reused reduces the waste products released as a result of the process. Reusable materials are more preferred in order not to harm nature.

The system of at least one embodiment of the invention also provides an advantage in terms of usability thanks to its compact structure.

### REFERENCE NUMBERS IN FIGURES

1. Inlet port
2. Separator
3. Oil separation chamber
4. Oil-absorbing layer
5. Second oil trap
6. Water outlet port
7. Depressurization chamber
8. Filter
9. Pressure port
10. O-ring
11. Diverter
12. Stage passage pipe
13. Spring
14. First cap
15. Second cap
16. Housing
17. Cartridge
18. Slot
19. Cap
20. Float
21. Gap
22. Oil outlet port
23. Waste oil collection bottle
24. Metal clips
25. Outer sheet
26. Inner sheet
27. Filter element
28. Separator cap

1. A system for separating oil-water condensate from the compressor in compressed air lines, comprising:
a first oil trap comprising at least one separator entering the system and allowing first stage separation of water-oil containing compressor drainage,
at least one oil separation chamber in which liquid passing through the at least one separator in the first oil trap is collected, enabling a second stage separation process to be carried out based on density difference and separating oil due to its density difference,
at least one second oil trap with at least one oil absorbing layer having oleophilic and hydrophobic properties for a third stage separation process, is the at least one second oil trap located in the at least one oil separation chamber and through which the liquid separated from the oil is transmitted, and
at least one third oil trap containing activated carbon material, through which liquid from the at least one second oil trap is conveyed, causing the oil to be retained and thereby performing a fourth stage separation process.

2. A system according to claim 1, wherein the at least one oil absorbing layer comprises a mixture of synthetic fibers.

3. A system according to claim 2, wherein the mixture of synthetic fibers is a mixture of recycled synthetic fibers.

4. A system according to claim 1, further comprising a depressurization chamber with at least one inlet port for entering the condensate, which allows condensate pressure to be reduced to prevent inlet pressure from damaging components in the system.

5. A system according to claim 4, wherein the depressurization chamber comprises at least one pressure port with at least one filter for discharging incoming excess compressed air.

6. A system according to claim 4, comprising at least one diverter in the depressurization chamber for transmitting the condensate reduced to atmospheric pressure to the at least one separator with a stable flow.

7. A system according to claim 1, wherein at least one separator comprises at least one perforated inner sheet, at least one perforated outer sheet positioned to surround the at least one perforated inner sheet, and at least one filter element located between the at least one perforated inner sheet and the at least one perforated outer sheet.

8. A system according to claim 7, further comprising at least one separator cap for securing the at least one perforated outer sheet, the at least one perforated inner sheet, and the at least one filter element, the at least one separator cap having at least one slot for seating the at least one perforated outer sheet, the at least one perforated inner sheet, and the at least one perforated filter element, and at least one hole through which drainage can pass.

9. A system according to claim 1, further comprising at least one spring in the at least one second oil trap for squeezing the at least one oil absorbing layer and disposing of the oil accumulated on the at least one oil absorbing layer, thereby making the at least one second oil trap reusable.

10. A system according to claim 9, further comprising a first cap and a second cap with a permeable structure, positioned between the at least one oil absorbing layer and the at least one spring of the at least one second oil trap.

11. A system according to claim 1, further comprising a housing in the at least one second oil trap, carrying the at least one oil absorbing layer and having a permeable structure to allow fluid passage after the third stage separation process.

12. A system according to claim 1, further comprising at least one channel and/or at least one stage passage pipe for transferring the liquid resulting from the separation of oil in the at least one oil separation chamber to the at least one second oil trap.

13. A system according to claim 1, wherein the at least one third oil trap comprises at least one cartridge in which the activated carbon material is positioned.

14. A system according to claim 13, wherein the at least one cartridge contains at least one slot for fixing the activated carbon material.

15. A system according to claim 13, further comprising at least one cap on the at least one cartridge, at least one float, and at least one gap for the passage of the at least one float on the at least one cap, which indicates that an amount of liquid in the at least one oil separation chamber has reached a risky level.

16. A system according to claim 1, further comprising at least one oil outlet port for removal of the oil phase from the system, which remains on top due to the density difference in the at least one oil separation chamber.

17. A method for separating oil-water condensate, the method comprising:
for a system separating oil-water condensate from a compressor in compressed air lines:
introducing water-oil containing drainage coming out of the compressor into the system through at least one inlet port and transmitting the water-oil to separator in a first oil trap,
performing first stage separation process in the separator,
transmitting liquid passing through the separator an oil separation chamber to separate the water and oil based on the density difference for performing a second stage separation process,
transmitting the liquid contained in the oil separation chamber and separated from the oil to a second oil trap comprising at least one oleophilic and at least one oil absorbing layer with hydrophobic properties for performing a third stage separation process,
transmitting the liquid exiting the second oil trap to a third oil trap containing activated carbon material for retaining the oil, thereby performing a fourth stage separation process, and
removing the de-oiled water from the system.
